(19) United States
(12) Patent Application Publication
(10) Pub. No.: US 2024/0273747 A1
(43) Pub. Date: Aug. 15, 2024

(54) METHOD FOR CALCULATING CRACK LINE LENGTH IN BUILDING SUBJECT TO SAFETY DIAGNOSIS, AND WORKER TERMINAL HAVING PROGRAM FOR EXECUTING METHOD FOR CALCULATING CRACK LINE LENGTH IN BUILDING SUBJECT TO SAFETY DIAGNOSIS INSTALLED THEREON

(71) Applicant: HANSTYLE ENGINEERING CO., LTD., Seoul (KR)

(72) Inventor: Da Woon JEONG, Seoul (KR)

(21) Appl. No.: 18/567,356

(22) PCT Filed: Apr. 4, 2022
(86) PCT No.: PCT/KR2022/004769

§ 371 Date: Jan. 29, 2024

(30) Foreign Application Priority Data
Jun. 7, 2021 (KR) 10-2021-0073693

(51) Int. Cl. G06T 7/60; G06F 3/0484; G06F 3/0488; G06T 7/00

(52) U.S. Cl. CPC G06T 7/60; G06F 3/0484; G06F 3/0488; G06T 7/0002; G06T 2200/24; G06T 2207/20092; G06T 2207/30184

(57) ABSTRACT

Provided are a method for computing a crack line length in a safety assessment target building and a worker terminal installed with a program for executing the method for computing a crack line length in a safety assessment target building. Provided is implemented through processes which are performed by the worker terminal and include: outputting a photographic image of an inspection target area in a photographing space, which is a space where a worker performs photography, through a touch-sensitive display; receiving touch information of the worker moving on the touch-sensitive display along a crack line included in the photographic image; generating shape information of the crack line based on the touch information; and computing a length of the crack line based on the shape information of the crack line.

### TECHNICAL FIELD

The present invention relates to a method for computing crack line lengths in a safety assessment target building and a worker terminal installed with a program for executing the method for computing a crack line length in a safety assessment target building, and more particularly, to a method for computing a crack line length in a safety assessment target building, in which a worker continuously touches a crack line of an inspection target area on a touch-sensitive display on which a photographic image of the inspection target area is output, such that a shape of the crack line is recognized by a worker terminal, and a length of the crack line may be computed by the worker terminal based on the recognized shape of the crack line, thus to calculate the length of the crack line with great accuracy, and a worker terminal installed with a program for executing the method for computing a crack line length in a safety assessment target building.

### BACKGROUND ART

Commonly, a worker who visits a safety assessment target building for performing a safety assessment due to aging of the building, such as an occurrence of cracks, moves around inside the corresponding building and take pictures an area where cracks have occurred, such as walls, columns, slabs, beams and the like.

As described above, the worker takes on-site pictures for each inspection target area of the building and then writes a building assessment report. During this process, the worker separately creates crack state drawings by referring to the pictures taken on the cracked area of the building.

As described above, it takes separate time and effort for the worker to create the crack state drawings. In addition, when the worker creates the crack state drawings by referring to the pictures taken on the cracked area such as the walls, columns, slabs, beams, and the like, the shape and size of the cracks may be expressed inaccurately, unlike their actual shape and size.

In addition, to perform safety diagnostic inspection of the building, an incidence of the cracks (i.e., a length of the crack line) should be measured and managed very accurately. However, conventionally, the work is carried out in a way that the worker creates the crack state drawings by referring to the pictures taken on the cracked area of the building, such that there is a problem that the length of the crack line cannot be accurately measured.

### SUMMARY OF INVENTION

### Problems to be Solved by Invention

Therefore, it is an object of the present invention to provide a method for computing a crack line length in a safety assessment target building, in which a worker continuously touches a crack line of an inspection target area on a touch-sensitive display on which a photographic image of the inspection target area is output, such that a shape of the crack line is recognized by a worker terminal, and a length of the crack line may be computed by the worker terminal based on the recognized shape of the crack line, thus to calculate the length of the crack line with great accuracy, and a worker terminal installed with a program for executing the method for computing a crack line length in a safety assessment target building.

### Means for Solving Problems

To achieve the above object, according to an aspect of the present invention, there is provided a method for computing a crack line length in a safety assessment target building including: (a) outputting, by a worker terminal, a photographic image of an inspection target area in a photographing space, which is a space where a worker performs photography, through a touch-sensitive display; (b) receiving, by the worker terminal, touch information of the worker moving on the touch-sensitive display along a crack line included in the photographic image; (c) generating, by the worker terminal, shape information of the crack line based on the touch information; and (d) computing, by the worker terminal, a length of the crack line based on the shape information of the crack line.

In addition, the step (d) may include: (d1) changing, by the worker terminal, a curved section included in the crack line into a straight section; and (d2) computing, by the worker terminal, the length on the photographic image of the crack line based on length information of the straight section.

In addition, the step (d) may include (d3) computing, by the worker terminal, an actual length of the crack line based on scale information of the photographic image and length information on the photographic image of the crack line.

Further, the worker terminal may calculate a length on the photographic image of the straight section of an object included in the photographic image, search for the object on the drawing image of the photographing space, search for actual length information of the straight section of the searched object, and calculate the scale information of the photographic image based on the length information on the photographic image of the straight section and actual length information of the straight section.

Further, there is provided a worker terminal including a program installed therein to execute the method for computing a crack line length in a safety assessment target building.

### Advantageous Effects

According to the present invention, as the worker continuously touches a crack line of an inspection target area on a touch-sensitive display on which a photographic image of the inspection target area is output, a shape of the crack lines is recognized by a worker terminal, and the length of the crack line may be computed by the worker terminal based on the shape of the crack line recognized as described above, thus to calculate the length of the crack line with great accuracy.

### BRIEF DESCRIPTION OF DRAWINGS

FIG. 1 is a procedural flowchart describing execution processes of a method for computing a crack line length in a safety assessment target building according to an embodiment of the present invention.

FIGS. 2 to 5 are views illustrating screen statuses of a worker terminal in execution processes of the method for computing a crack line length in a safety assessment target building according to an embodiment of the present invention.

FIG. 6 is a procedural flowchart describing processes of computing the length of the crack line based on shape information of the crack line in the method for computing a crack line length in a safety assessment target building according to an embodiment of the present invention.

FIG. 7 is a procedural flowchart describing processes of obtaining scale information of the photographic image in the method for computing a crack line length in a safety assessment target building according to an embodiment of the present invention.

### Mode for Carrying out Invention

Hereinafter, the present invention will be described with reference to the accompanying drawings in detail. Referring to the drawings, like reference characters designate like or corresponding parts throughout the several views. In the embodiments of the present invention, the publicly known functions and configurations that are judged to make the purport of the present invention unnecessarily obscure will not be described.

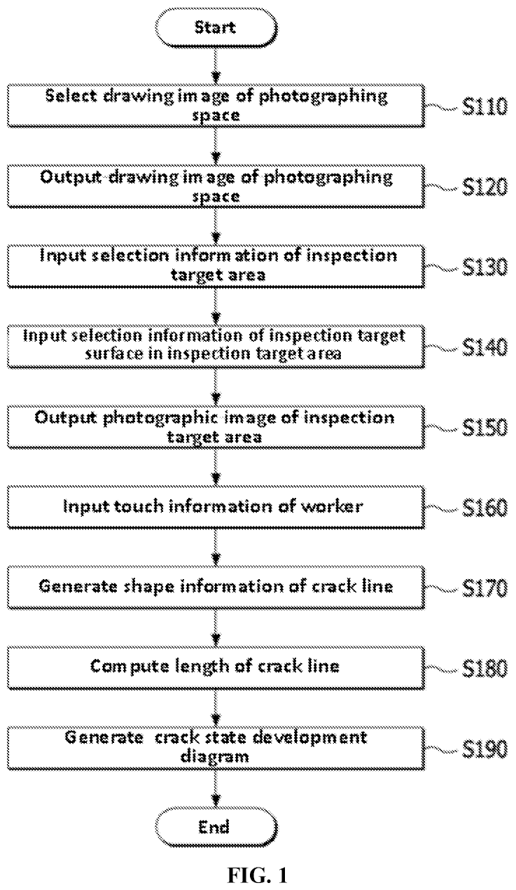

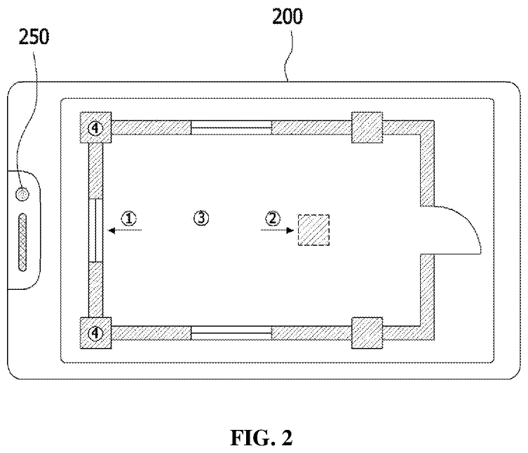

FIG. 1 is a procedural flowchart describing execution processes of a method for computing a crack line length in a safety assessment target building according to an embodiment of the present invention, and FIGS. 2 to 5 are views illustrating screen statuses of a worker terminal in execution processes of the method for computing a crack line length in a safety assessment target building according to an embodiment of the present invention.

Meanwhile, a worker terminal 200 in the present invention may be a wireless communication terminal such as a smartphone or tablet PC possessed by a worker who performs safety assessment of a building, and the worker terminal 200 may include an application program installed therein to execute the method for computing a crack line length in a safety assessment target building according to the present invention.

Hereinafter, execution processes of the method for computing a crack line length in a safety assessment target building according to an embodiment of the present invention will be described with reference to FIGS. 1 to 5.

First, a worker who visits a safety assessment target building for inspection due to aging of the building, such as an occurrence of cracks selects a plan view image file of a floor currently being diagnosed among the plan view image files for each floor of the corresponding building stored in the worker terminal 200 (S110).

Specifically, when the worker is conducting a safety assessment on the first floor of the corresponding building, the worker selects a plan view image file of the first floor among the plan view image files for each floor stored in the worker terminal 200, and thus the plan view image of the corresponding floor is output on a screen of the worker terminal 200 as shown in FIG. 2 (S120).

Thereafter, the worker who performs the safety assessment while moving around inside the corresponding floor checks the status of cracks in inspection target areas, such as walls, columns, slabs and beams, etc., and determines whether to capture an image of the corresponding inspection target area.

As such, when it is determined to capture an image of the inspection target area, the worker selects the inspection target area that has been determined to capture an image on the plan view image of the corresponding floor displayed on the screen of the worker terminal 200 in a manner of touching the screen, etc., as shown in FIG. 2 (S130).

Meanwhile, in carrying out the present invention, the worker can additionally input selection information of a specific inspection target surface in the inspection target area on the plan view image output on the screen of the worker terminal 200 in a manner of touching the screen, etc., (S140).

Specifically, when the inspection target area is a wall, the worker selects the corresponding wall on the plan view image output on the screen of the worker terminal 200 in a manner of touching the screen, etc. In this case, the worker may select the specific inspection target surface in the corresponding wall by distinguishing between the front and rear of the wall, or as shown in FIG. 2, may input selection information of the inspection target surface by executing a swipe motion \textcircled{1}, which is an operation of moving a finger toward the inspection target surface of the corresponding wall.

In addition, when the inspection target area is a pillar, the worker selects the corresponding pillar on the plan view image output on the screen of the worker terminal 200 in a manner of touching the screen, etc. In this case, if the corresponding pillar is a square pillar, the worker may select the inspection target surface by distinguishing between four sides of the pillar, or as shown in FIG. 2, input selection information of the inspection target surface by executing the swipe motion \textcircled{2}, which is an operation of moving the finger toward the inspection target surface on the corresponding pillar.

In addition, when the inspection target area is the slab, the worker performs an operation \textcircled{3} of pressing the corresponding slab with a finger on the plan view image output on the screen of the worker terminal 200 for a predetermined reference time (for example, 1 second) or more, thus to select the inspection target area. In this case, when pressing with one finger, an upper surface of the slab (i.e., a bottom surface) may be selected as the inspection target surface in the corresponding slab, and when pressing simultaneously with two or more fingers (multi-touch)), a lower surface of the slab (i.e., a ceiling surface of the lower floor) may be selected as the inspection target surface in the corresponding slab.

In addition, when the inspection target area is the beam, the worker performs an operation \textcircled{4} of pressing a pair of pillars respectively connected to left and right ends of the corresponding beam at the same time with each finger on the plan view image of the corresponding floor output on the screen of the worker terminal 200, thus to select the inspection target area. In this case, when pressing with one finger, the lower surface of the beam may be selected as the inspection target surface in the corresponding beam, when multi-touching with two fingers, the left side of the corresponding beam may be selected as the inspection target surface, and when multi-touching using three fingers, the right side of the corresponding beam may be selected as the inspection target surface.

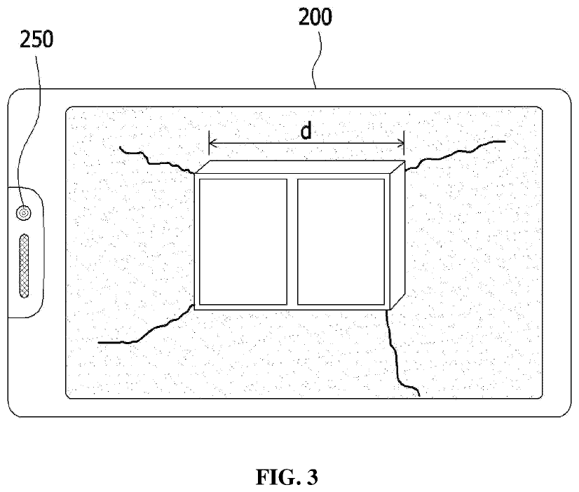

As described above, when selecting the inspection target area and the specific inspection target surface in the inspection target area, and then the worker captures an image of the inspection target surface using a camera module 250 provided in the worker terminal 200, the photographic image of the inspection target surface is stored in an internal memory provided in the worker terminal 200, and the corresponding photographic image is output through a touch-sensitive display of the worker terminal 200 as shown in FIG. 3 (S150).

Meanwhile, in carrying out the present invention, it is preferable that the worker terminal 200 stores selection information of the inspection target area and inspection target surface selected by the worker in the above-described steps S130 and S140 in association with the photographic image stored in the above-described step S150.

Accordingly, when the worker reselects the inspection target surface selected by the touch screen manner in the above-described steps S130 and S140 on the image of the corresponding plan view output on the worker terminal 200, the photographic image stored in association with the corresponding inspection target surface in the above-described step S150 is output through the screen of the worker terminal 200, such that it is possible to more efficiently support the assessment report writing work of the worker.

In addition, in carrying out the present invention, the worker terminal 200 may additionally store information on a photographing order at the diagnosis site of the corresponding photographic image in association with the photographic image stored in the above-described step S150.

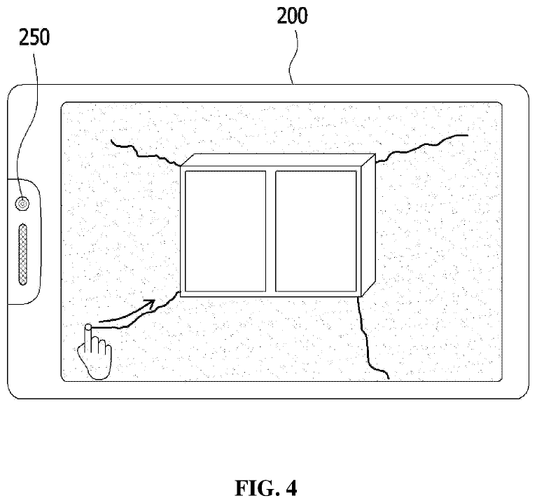

Meanwhile, as shown in FIG. 3, when the worker who has checked the crack line included in the photographic image of the inspection target area through the touch-sensitive display of the worker terminal 200 touches a start point of the crack line on the display screen using a finger or an electronic pen such as a stylus pen, as shown in FIG. 4, and in this state, continuously drags along the crack line, the worker terminal 200 receives touch information of the worker continuously dragging along the crack line included in the photographic image (S160).

In carrying out the present invention, the worker may input the touch information in a state where the photographic image output on the touch-sensitive display screen of the worker terminal 200 in the above-described step S150 is enlarged, in order to increase the accuracy of touch information input by dragging along the crack line.

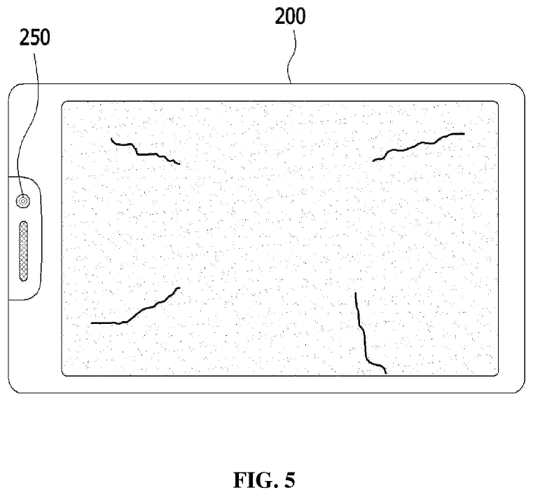

Meanwhile, the worker terminal 200 generates shape information of the crack line based on the touch information input as described above as shown in FIG. 5 (S170), and computes the length of the crack line by analyzing the generated shape information of the crack line (S180).

As described above, according to the present invention, as the worker continuously touches the crack lines of the inspection target area on the touch-sensitive display on which the photographic image of the inspection target area is output, the length of the crack line may be computed based on shape information of the crack line recognized by the worker terminal 200, thus to calculate the length of the crack line with great accuracy.

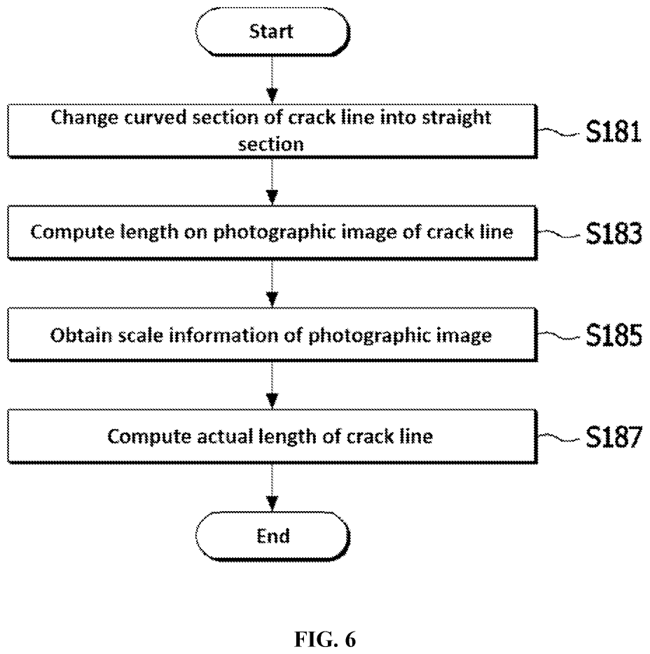

FIG. 6 is a procedural flowchart describing processes of computing the length of the crack line based on the shape information of the crack line in the method for computing a crack line length in a safety assessment target building according to an embodiment of the present invention. Hereinafter, the processes of computing the length of the crack line based on the shape information of the crack line will be described with reference to FIG. 6.

First, the worker terminal 200 continuously analyzes the shape of the crack line generated as shown in FIG. 5 in a direction in which the crack line is developed, thereby dividing the crack line into a straight section and a curved section, and then may change the curved section into a straight section connecting the start point and end point of the corresponding curved section (S181).

Next, the worker terminal 200 may compute the length of each straight section constituting the crack line, and sum the lengths of each straight section to calculate a total length on the photographic image of the crack line (S183).

Meanwhile, the worker terminal 200 may obtain scale information of the photographic image captured in the above-described step S150 in order to convert the length on the photographic image of the crack line calculated as described above into the actual length of the crack line (S185).

In addition, in carrying out the present invention, the worker terminal 200 may perform the procedure for obtaining the scale information of the photographic image after storing the photographic image in the above-described step S150.

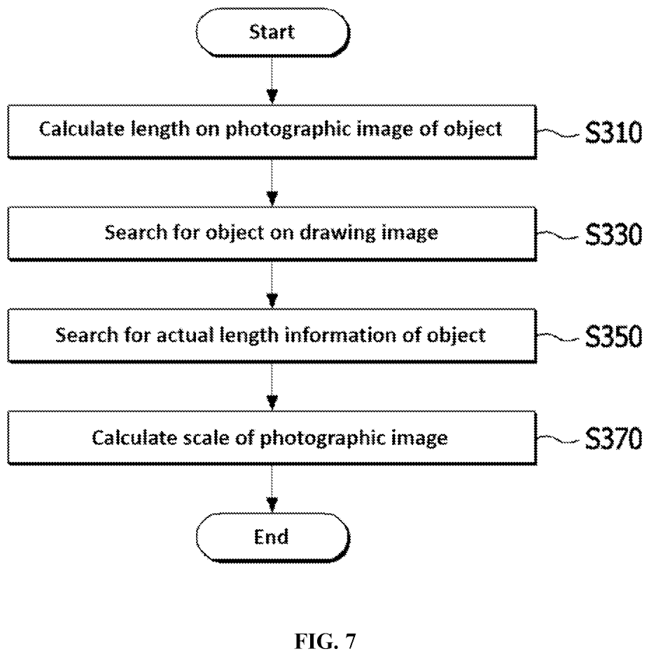

FIG. 7 is a procedural flowchart describing processes of obtaining scale information of the photographic image in the method for computing a crack line length in a safety assessment target building according to an embodiment of the present invention. Hereinafter, the processes of obtaining scale information from a photographic image will be described with reference to FIG. 7.

First, the worker terminal 200 calculates a straight line length d such as a horizontal width on the photographic image of an object such as a window frame included in the photographic image in the above-described step S150 (S310).

Next, the worker terminal 200 searches for the same object such as the window frame, on a drawing image of the photographing space in the above-described step S120 based on the shape information of the object on the photographic image (S330), and then may search for information of an actual straight line length D such as the horizontal width of the corresponding object, which is stored in the worker terminal 200 together with the drawing image (S350).

Accordingly, the worker terminal 200 may calculate scale information d/D of the photographic image based on the straight line length d such as the horizontal width on the photographic image of the object calculated in the above-described step S310 and the actual straight line length D such as the horizontal width of the object searched in the above-described step S350 (S370).

The worker terminal 200 that has calculated the scale information of the photographic image as described above may apply the scale information d/D of the corresponding photographic image to a length 1 on the photographic image of the crack line calculated in the above-described step S183, thereby calculating the actual length L of the crack line according to Equation 1 below (S187).

$$L = 1 \div ( d / D ) \qquad [ Equation 1 ]$$

Wherein L is the actual length of the crack line, 1 is the length on the photographic image of the crack line, and d/D is a scale value of the photographic image.

Meanwhile, in carrying out the present invention, the worker terminal 200 may generate a development diagram (for example, an elevation view of the wall, etc.) of the inspection target area based on the photographic image captured and stored in the above-described step S150.

In carrying out the present invention, when the inspection target area is a wall, the worker terminal 200 may generate a development diagram of the wall based on numerical information such as the width and length of the corresponding wall stored together with the plan view selected by the worker in the above-described step S110, thereby increasing the accuracy of the development diagram creation work.

Meanwhile, the worker terminal 200 may perform overlapping the actual length information of the crack line calculated according to Equation 1 above with the shape information of the crack line generated based on the touch information of the worker in the development diagram for the inspection target surface generated as described above, thereby generating a crack state development diagram for the inspection target area as shown in FIG. 5 (S190).

Terms used in the present invention are used only to describe specific embodiments, and are not intended to limit the present invention. Singular expressions used herein include plural expressions unless they have definitely opposite meanings in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

While the present invention has been described with reference to the preferred embodiments and modified examples, the present invention is not limited to the above-described specific embodiments and the modified examples, and it will be understood by those skilled in the art that various modifications and variations may be made therein without departing from the scope of the present invention as defined by the appended claims, as well as these modifications and variations should not be understood separately from the technical idea and prospect of the present invention.

### Industrial Applicability

The present invention may be applied to the technical field related to safety assessment of buildings, such that industrial applicability thereof is recognized.

1. A method for computing a crack line length in a safety assessment target building comprising:
(a) outputting, by a worker terminal, a photographic image of an inspection target area in a photographing space, which is a space where a worker performs photography, through a touch-sensitive display;
(b) receiving, by the worker terminal, touch information of the worker moving on the touch-sensitive display along a crack line included in the photographic image;
(c) generating, by the worker terminal, shape information of the crack line based on the touch information; and
(d) computing, by the worker terminal, a length of the crack line based on the shape information of the crack line.

2. The method for computing a crack line length in a safety assessment target building according to claim 1, wherein the step (d) comprises:
(d1) changing, by the worker terminal, a curved section included in the crack line into a straight section; and
(d2) computing, by the worker terminal, the length on the photographic image of the crack line based on length information of the straight section.

3. A worker terminal comprising a program installed therein to execute the method for computing a crack line length in a safety assessment target building according to claim 1.

4. A worker terminal comprising a program installed therein to execute the method for computing a crack line length in a safety assessment target building according to claim 2.
